(19) United States
(12) Patent Application Publication
(10) Pub. No.: US 2011/0091170 A1
(43) Pub. Date: Apr. 21, 2011

(54) FIBER DISTRIBUTION HUB AND CABLE FOR USE THEREWITH

(75) Inventors: Oscar Fernando Bran de León, Belle Plaine, MN (US); Timothy Haataja, Prior Lake, MN (US); Wayne M. Kachmar, North Bennington, VT (US); Ronald J. Kleckowski, Manchester Center, VT (US)

(73) Assignee: ADC TELECOMMUNICATIONS, INC., Eden Prairie, MN (US)

(21) Appl. No.: 12/909,461

(22) Filed: Oct. 21, 2010

Related U.S. Application Data
(60) Provisional application No. 61/253,754, filed on Oct. 21, 2009.

(51) Int. Cl. G02B 6/44; G02B 6/46

(52) U.S. Cl. 385/100; 385/135

(57) ABSTRACT

A fiber distribution hub includes a swing frame pivotally mounted to an enclosure. The enclosure defines a cable port and at least a first interface region. The swing frame defines a splitter region, a termination region, and a storage region. Splitter modules can be oriented and positioned so that splitter pigtails extending from each of the splitter modules extend directly downwardly through a vertically extending channel. A cable clamp can be mounted to the enclosure at the cable port to secure one or more cables to the enclosure.

### CROSS-REFERENCE TO RELATED APPLICATION

This application claims the benefit of U.S. Provisional Patent Application Ser. No. 61/253,754, filed Oct. 21, 2009, which application is hereby incorporated by reference in its entirety.

### BACKGROUND

Passive optical networks are becoming prevalent in part because service providers want to deliver high bandwidth communication capabilities to customers.

Passive optical networks are a desirable choice for delivering high-speed communication data because they may not employ active electronic devices, such as amplifiers and repeaters, between a central office and a subscriber termination. The absence of active electronic devices may decrease network complexity and/or cost and may increase network reliability.

An example network can include a central office that connects a number of end subscribers (also called end users herein) in a network. For example, FIG. 1 is a schematic diagram of a network 100 including a central office 110 that connects a number of subscribers 115 in the network 100. The central office can additionally connect to one or more larger networks, such as the Internet (not shown) and a public switched telephone network (PSTN).

Some cables in the network 100 can be branched out from main cable lines 120 and routed to fiber distribution and access terminals (e.g., fiber distribution hubs or pedestals). For example, feeder cables can branch from main cable lines 120 at branch points 125 and be routed to FDHs 130. Such branched cables might extend from the FDHs 130 to smaller fiber access terminals (e.g., optical network terminals or drop terminals) 104 directly adjacent the business or home to which service may be provided. The various lines of the network can be aerial or housed within underground conduits.

Splitters used in FDHs 130 can accept feeder cables having a number of fibers and may split signals carried on those incoming fibers into, for example, 216 to 432 individual signals that may be associated with a like number of end user locations 115. In typical applications, an optical splitter is provided prepackaged in an optical splitter module housing and provided with splitter output pigtails that extend from the module. The splitter output pigtails are typically connectorized with, for example, SC, LC, or LX.5 connectors. The optical splitter module provides protective packaging for the optical splitter components in the housing and thus provides for easy handling for otherwise fragile splitter components. This modular approach allows optical splitter modules to be added incrementally to fiber distribution and access terminals as required.

Improvements to current fiber networks are desirable.

### SUMMARY

Certain aspects of the disclosure relate to fiber distribution hubs (FDHs) that provide an interface between the central office 110 and the end users 115. Certain aspects of the disclosure relate to features that reduce the profile and other dimensions of the FDH. Other aspects relate to features adapted to enhance access to components within the FDH. Still other aspects relate to features that enhance cable management, ease of use, and scalability.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

Referring to the drawing, wherein like numerals represent like parts throughout the several views:

FIG. 1 illustrates a network deploying passive fiber optic lines and including a central office that connects a number of end subscribers (also called end users herein) in a network in accordance with the principles of the present disclosure;

FIGS. 2-4 show an example FDH with an enclosure and a cover arranged in a closed position;

FIG. 5 is schematic diagram showing an example cable routing scheme for an example FDH;

FIGS. 6 and 7 show the example FDH of FIGS. 2-4 with the cover arranged in an open position and a swing frame removed;

FIGS. 8 and 9 show the example FDH of FIGS. 6 and 7 with a swing frame mounted to the enclosure and arranged in a closed position;

FIGS. 10 and 11 show the example FDH of FIGS. 8 and 9 with the swing frame in an open position;

FIGS. 12-14 show an example cable clamp suitable for use with the FDH disclosed herein;

FIGS. 15-19 show an example dual bend radius limiter suitable for use with the FDH disclosed herein;

FIG. 20 is a schematic diagram of a plug-and-play splitter arrangement suitable for use with the FDH disclosed herein; and

FIGS. 21-23 show an example cable suitable for use with the FDH disclosed herein.

### DETAILED DESCRIPTION

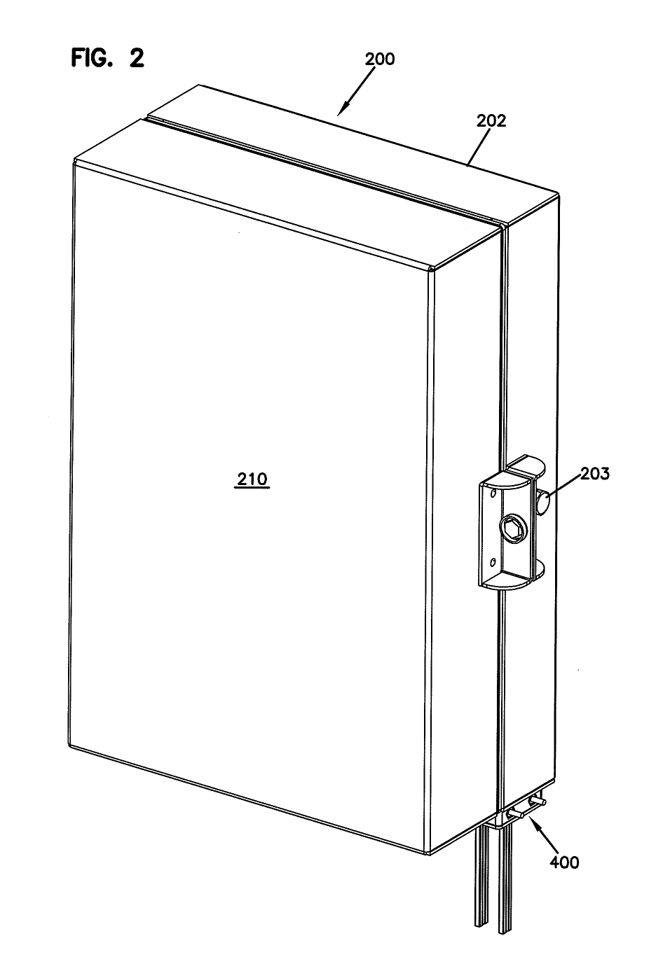

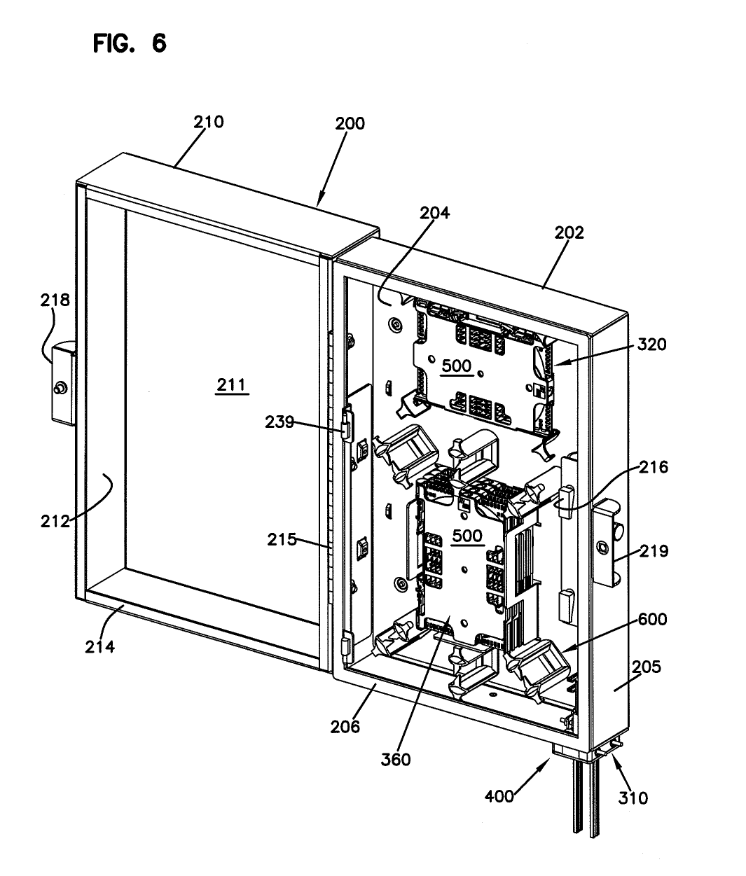

The present disclosure relates to a fiber distribution hub (FDH) 200 having a generally rectangular, low profile enclosure 202 (see FIGS. 2-4). The enclosure 202 has a generally rectangular main body having four sides 205 extending forwardly from a back panel 204 to define an interior. In the example shown, the four sides 205 include a top, a bottom, a left side, and a right side. The enclosure 202 also defines a generally open front side opposite the back wall 204 (e.g., see FIG. 6). A fascia 206 is mounted on the sides 205 to define the open front side of the enclosure 202. A spool 208 can be positioned on a rear exterior of the FDH 200 to provide cable storage.

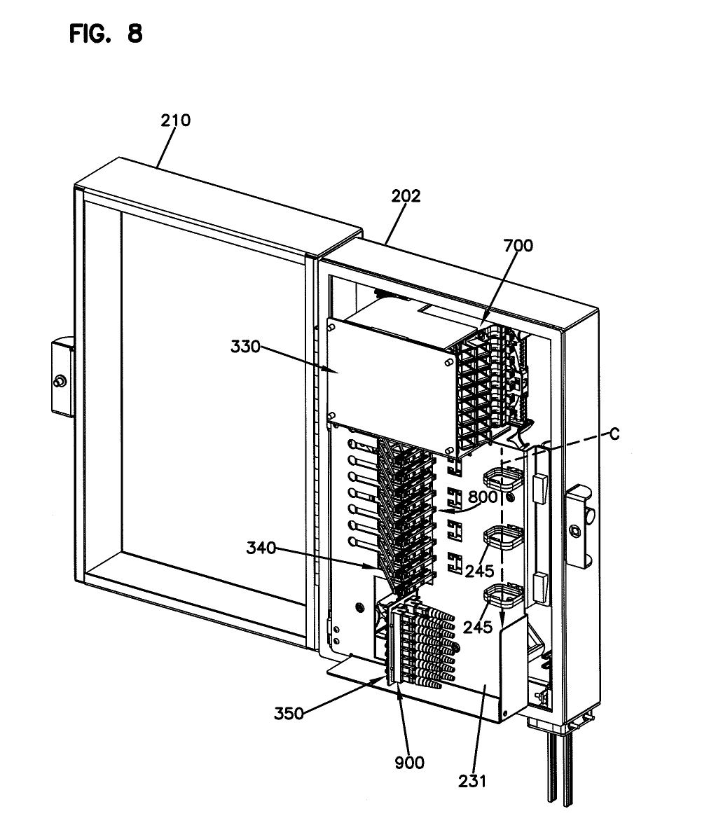

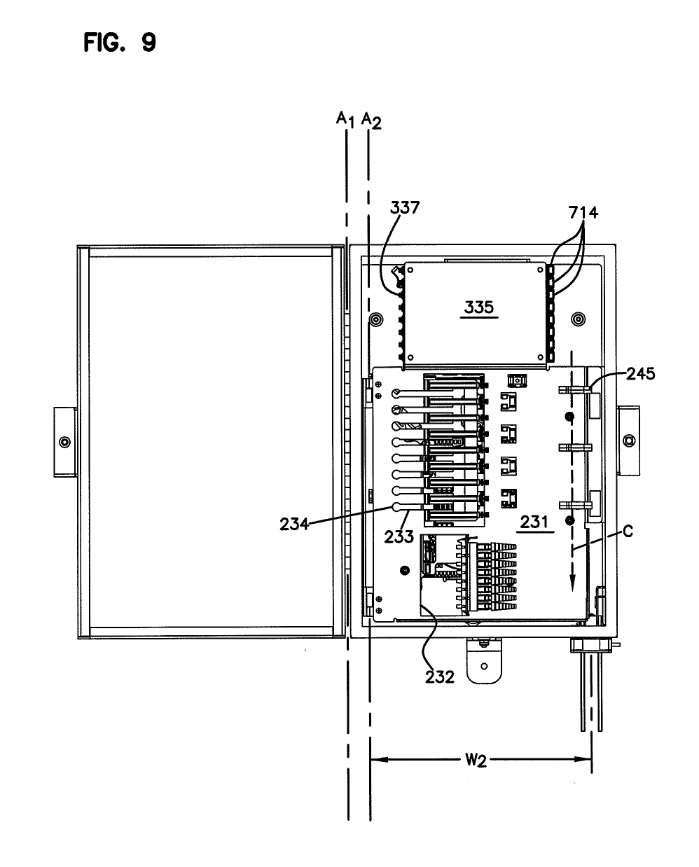

The enclosure 202 also includes a door 210 typically mounted at the open front side of the enclosure 202. The door 210 includes a front panel 211, four sides 212, and a fascia 214. The door 210 is pivotally movable about a hinge axis Al (FIG. 9) from an open position (see FIG. 6) in which the interior of the enclosure 202 can be accessed to a closed position (see FIG. 2) in which the open front side is at least partially covered. In one embodiment, the door 210 is mounted on one or more hinges 215. In certain embodiment, the enclosure 202 can include two or more doors 210 covering the open front side.

A seal can be provided at the interface between the door fascia 214 and the main body fascia 206 for sealing the enclosure 202 when the door 210 is closed. The enclosure 202 can be locked in the closed position using a locking arrangement including locking members 216. When a first handle 218, which is mounted to the door 210, engages with a second handle 219, which is mounted to the main body of the enclosure 202, the user can turn the locking members 216 to latch behind the door fascia 212.

In general, each enclosure 202 can include one or more telecommunications components including telecommunications circuits (e.g., optical outputs to subscribers). For example, in certain embodiments, an example enclosure can include no more than 576 circuits (e.g., no more than 576 fiber optic adapters such that the enclosure can provide 576 outputs to subscriber locations). In certain embodiments, an example enclosure can include no more than 288 circuits (e.g., no more than 288 fiber optic adapters such that the enclosure can provide 288 outputs to subscriber locations). In certain embodiments, an example enclosure can include no more than 144 circuits (e.g., no more than 144 fiber optic adapters such that the enclosure can provide 144 outputs to subscriber locations). In certain embodiments, an example enclosure can include no more than 96 circuits (e.g., no more than 96 fiber optic adapters such that the enclosure can provide 96 outputs to subscriber locations). In certain embodiments, an example enclosure can include no more than 72 circuits (e.g., no more than 72 fiber optic adapters such that the enclosure can provide 72 outputs to subscriber locations). In certain embodiments, an example enclosure can include no more than 64 circuits (e.g., no more than 64 fiber optic adapters such that the enclosure can provide 64 outputs to subscriber locations). Indeed, in certain embodiments, an example enclosure can include no more than 32 circuits (e.g., no more than 32 fiber optic adapters such that the enclosure can provide 32 outputs to subscriber locations).

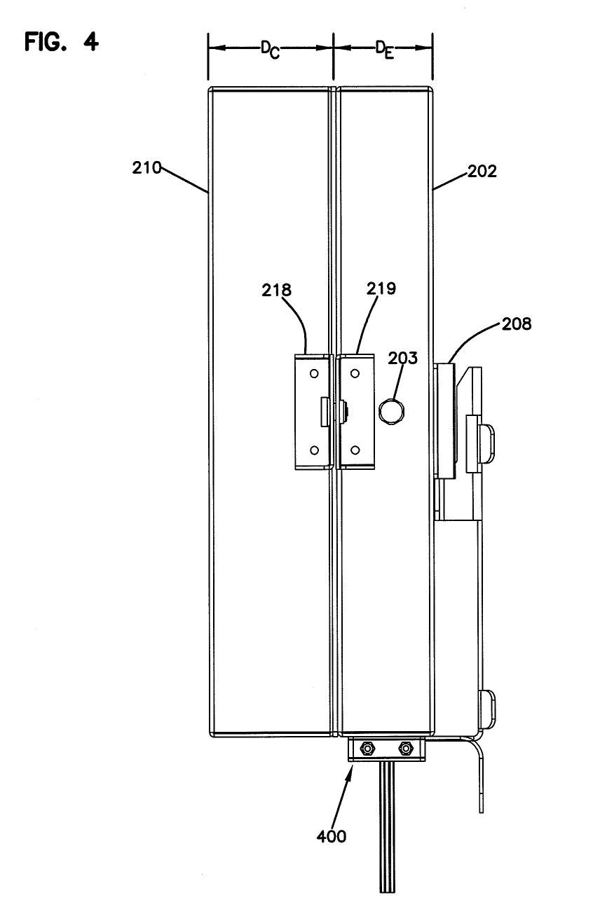

In accordance with aspects of the disclosure, the enclosure 202 is sized to be placed in a location without occupying a large amount of space. In certain embodiments, the enclosure 202 can have a depth D (see FIG. 4) of less than nine (9) inches (e.g., about twenty-three (23) centimeters). In certain embodiments, the enclosure 202 can have a depth D of less than seven (7) inches e.g., about eighteen (18) centimeters). Indeed, in certain embodiments, the enclosure 202 can have a depth D of less than six (6) inches. In other embodiments, however, the enclosure 202 may have depths greater than nine (9) inches.

The width W and height H of the enclosure 202 (see FIG. 2) can vary depending upon the number of circuits present in the fiber distribution hub 200. In certain embodiments, the height H of the enclosure 202 is greater than the width W, which is greater than the depth D. In other embodiments, the height H of the enclosure 202 is at least three times greater than the depth D and the width W of the enclosure 202 is at least 1.5 times the depth D. In still other embodiments, the width W of the enclosure 202 is at least twice the depth D. In further embodiments, the height H of the enclosure 202 is at least 5 times as large as the depth D and the width W of the enclosure 202 is at least two times as large as the depth D. For example, in one example embodiment of an FDH 200, the enclosure 202 can have a depth D of about 6 inches, a height H of about 17 inches, and a width W of about 12 inches. In other embodiments, however, example FDHs 200 can have different dimensions.

The FDH 200 generally administers connections at a termination field between incoming fiber and outgoing fiber. As the term is used herein, “a connection” between fibers includes both direct and indirect connections. Examples of incoming fibers include the fibers of a feeder cable that enters the enclosure 202 and intermediate fibers that connect the feeder cable fibers to the termination field. Examples of such intermediate fibers include connectorized pigtails extending from one or more splitter modules and fibers that extend from a splitter module and that are spliced or otherwise connected to the feeder cable. Examples of outgoing fibers include the fibers of the subscriber cable that exit the enclosure 202 and any intermediate fibers that connect the subscriber cable fibers to the termination field.

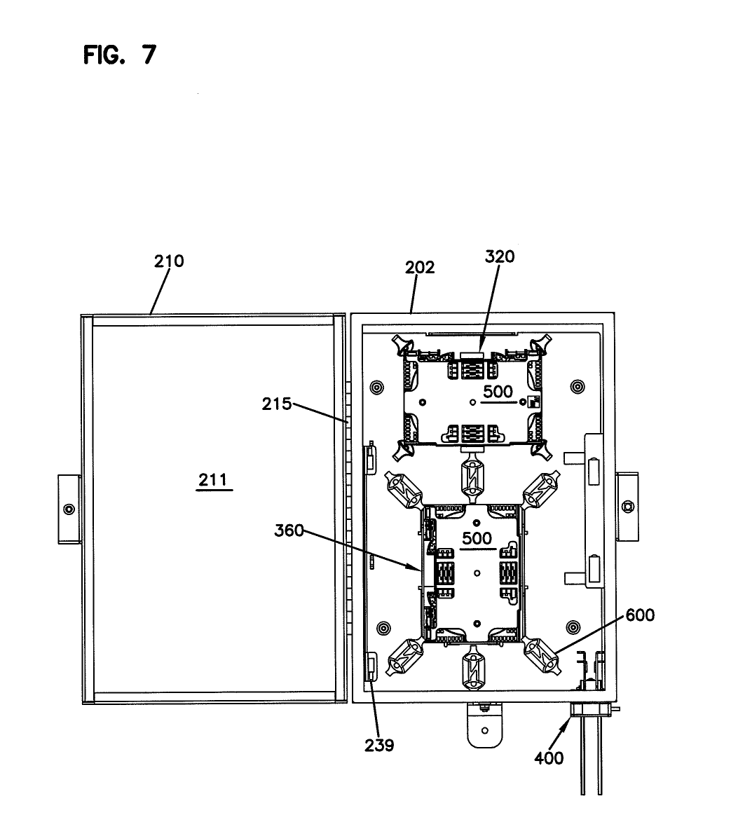

A number of telecommunications components can be mounted within the enclosure 202. For example, one or more cable clamps 400, one or more splice trays 500, and one or more bend radius limiters, such as dual bend radius limiters 600, can be mounted to the enclosure 202 as will be described in greater detail herein (e.g., see FIG. 6). In certain embodiments, the FDH 200 includes a swing frame 230 pivotally mounted to the enclosure 202 (e.g., see FIGS. 7-11).

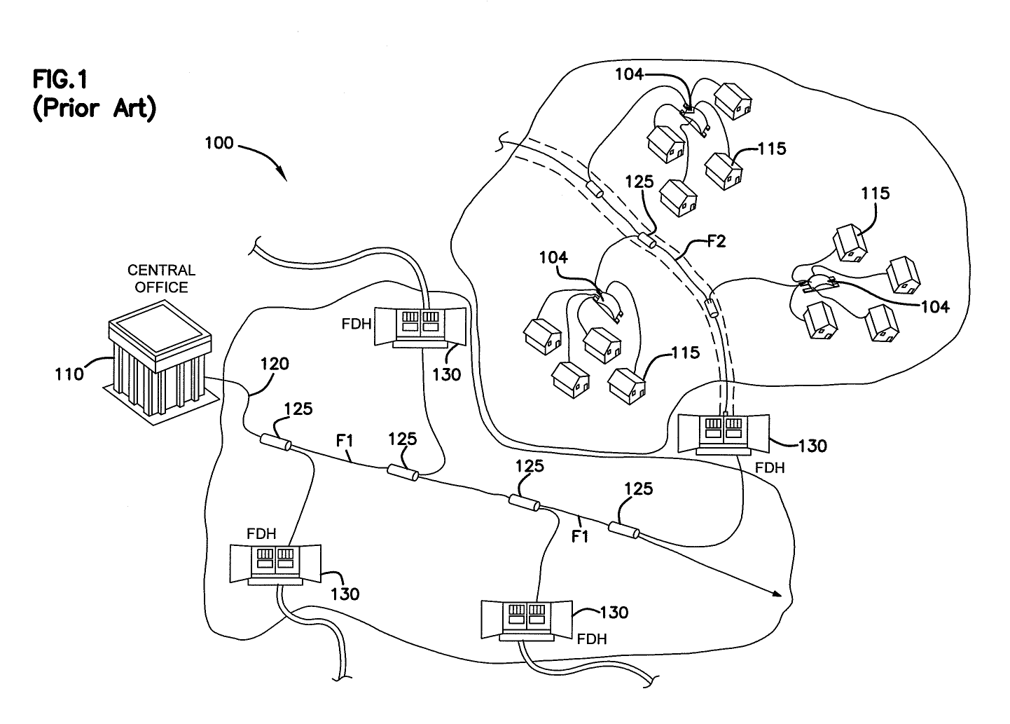

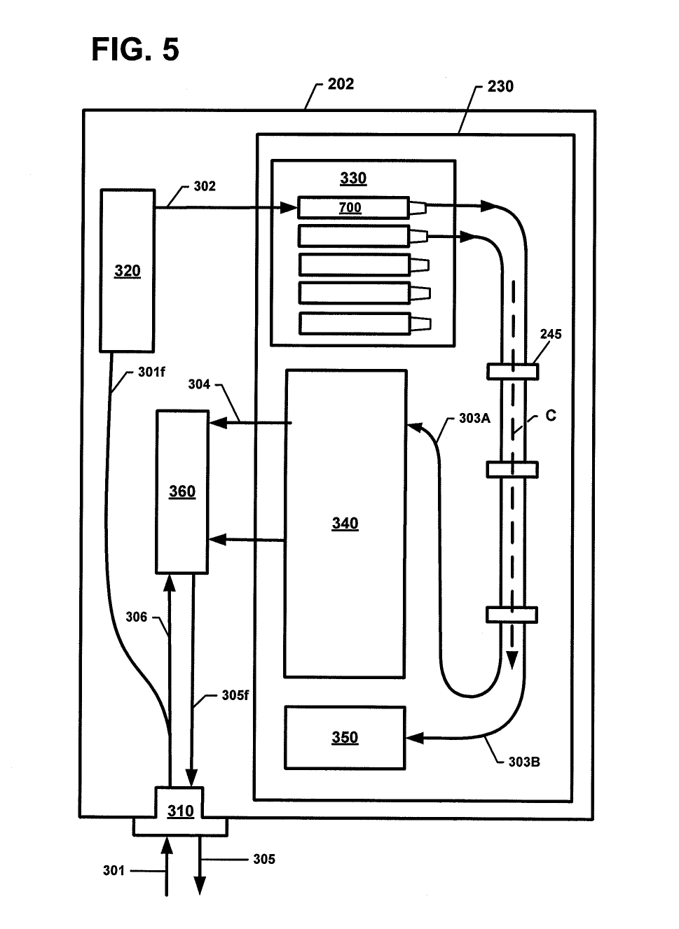

Some telecommunications components can be mounted to the swing frame 230. For example, as shown in FIG. 8, the swing frame 230 can include splitter modules 700, termination modules 800, and storage modules 900. FIG. 5 is schematic diagram showing an example cable routing scheme 300 for the FDH 200. As shown at FIG. 5, a feeder cable 301 and a subscriber cable 305 can be routed into the enclosure 202 through a port 310 defined in the enclosure 202 (e.g., typically through the back or bottom of the main body). An example feeder cable 301 may include twelve to forty-eight individual fibers 301f connected to a service provider central office 110 (FIG. 1). In accordance with some aspects, the cables 301, 305 are secured to the enclosure 202 at the cable port 310 by a cable clamp 400.

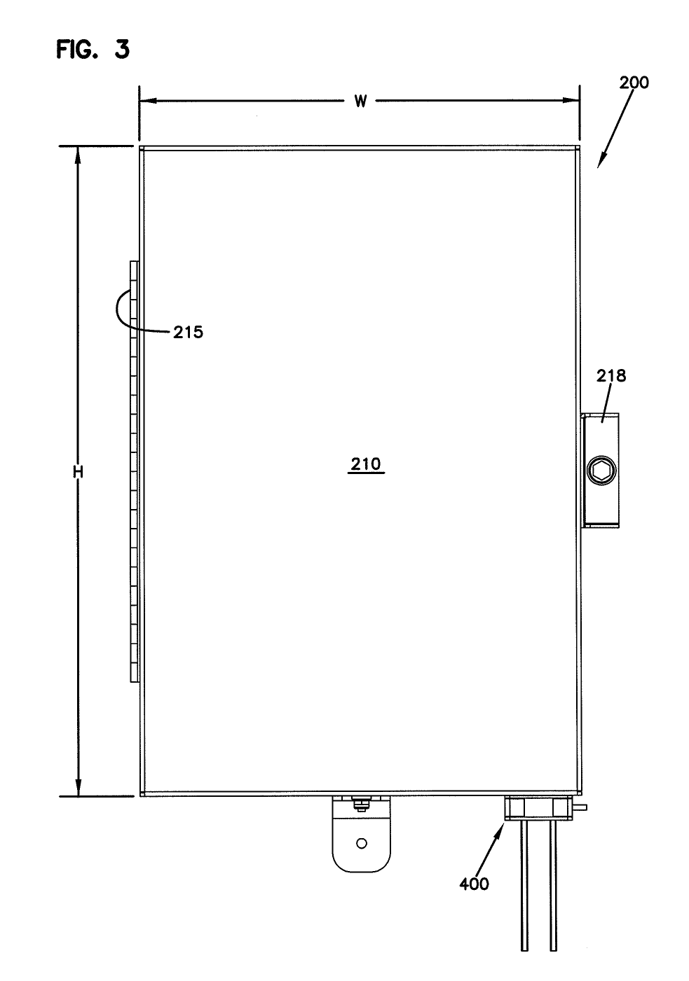

One or more fibers 301f of the feeder cable 301 can be routed from the cable port 310 to a first fiber interface 320. In certain embodiments, the first fiber interface 310 is located within the enclosure 202 and not located on the swing frame 230. For example, the first fiber interface 310 can be located on the back wall 204 of the enclosure 202 (see FIG. 3).

In accordance with some aspects of the disclosure, the fiber interface 320 includes one or more splice trays 500. In accordance with other aspects, however, the first fiber interface 320 can include other types of interfaces, such as one or more fiber optic adapters, adapter modules, or fiber fanouts. In some embodiments, the first fiber interface 320 is mounted to the enclosure 202. In other embodiments, however, the first fiber interface 320 can be mounted to the swing frame 230.

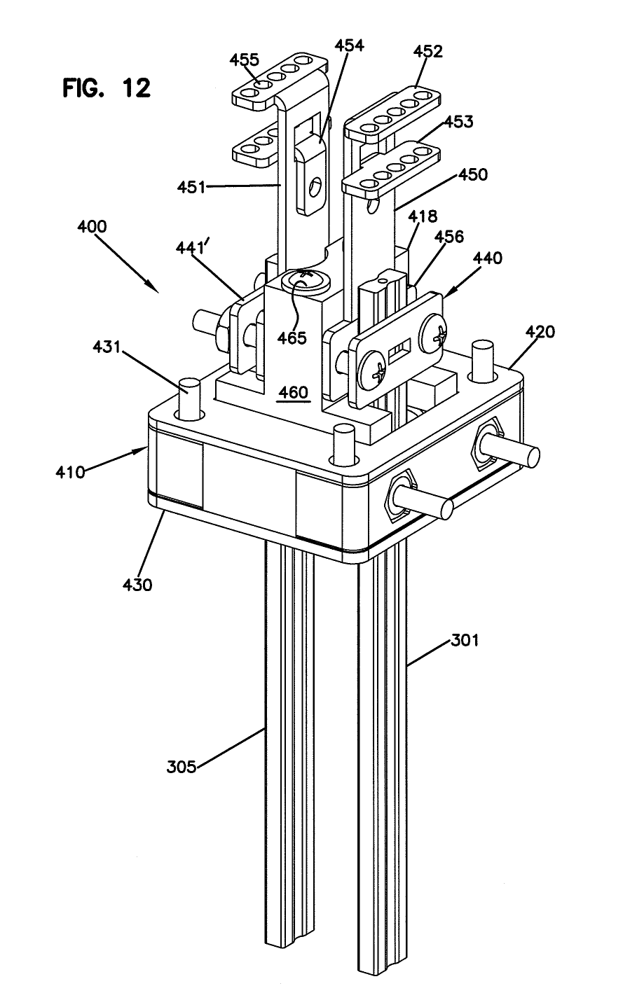

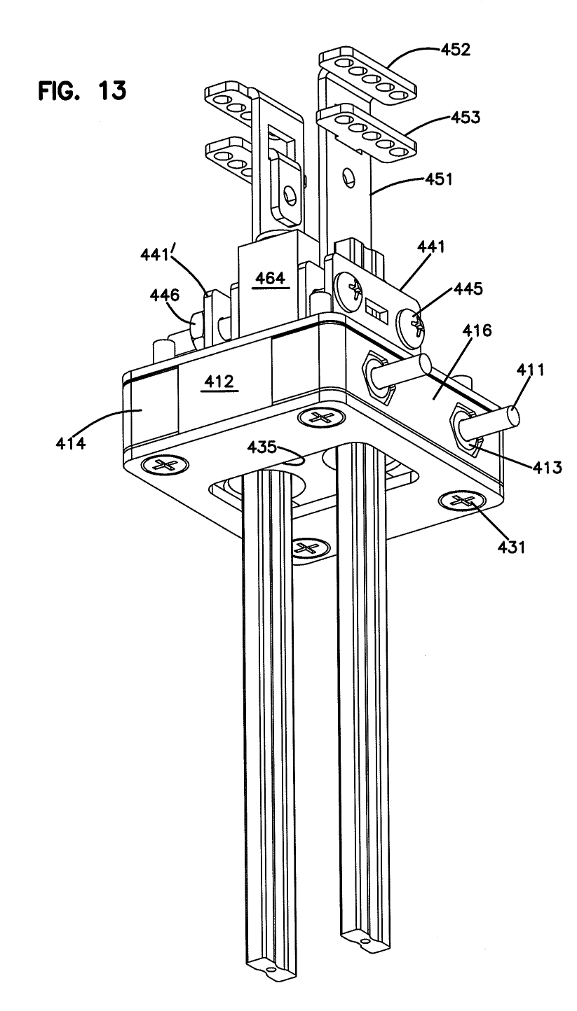

In accordance with some aspects, the fibers 301f are upjacketed or otherwise protected between the port 310 and the fiber interface 320. One example upjacketing arrangement is discussed herein with respect to FIGS. 12-14. In some embodiments, the fibers 301f can be separated into one or more groups of optical fibers, with a buffer tube surrounding each group. For example, the fibers 301f can be separated into feeder fibers and subscriber fibers. Each group of optical fibers can be routed to a different tray. In accordance with other aspects, however, the fibers 301f are bare optical fibers (i.e., are not protected by buffer tubes).

At the fiber interface 320, at least a portion of the feeder fibers 301f are optically coupled to splitter input fibers 302. The splitter input fibers 302 are routed from the fiber interface 320 to a splitter region 330 of the FDH 200. In certain embodiments, the splitter region 330 is located on the swing frame 230. At the splitter region 330, the input fibers 302 are connected to separate splitter modules 700, in which signals carried over the input fibers 302 are each split into multiple signals carried over connectorized splitter pigtails 303. The ends of the input fibers 302 also can be connectorized and can be connected to the splitter modules 700 by fiber optic adapters as will be disclosed in greater detail herein. A typical splitter pigtail 303 includes a coated (and possibly buffered) fiber, a jacket covering the fiber, and strength members (e.g., aramid yarn) positioned between the fiber and the jacket.

When the splitter pigtails 303 are not in service, the connectorized ends can be temporarily stored on a storage region 350. For example, the connectorized ends of the splitter pigtails 303 can be held at storage modules 900. In certain embodiments, the storage region 330 is located on the swing frame 230. When the pigtails 303 are needed for service, the pigtails 303 are routed from the splitter region 330 to a termination field 340. For example, the connectorized ends of the splitter pigtails 303 can be plugged into termination modules 800. In certain embodiments, the termination field 340 is located on the swing frame 230.

The splitter modules 700 are arranged so that the splitter pigtails 303 are routed along a vertical channel C between the splitter region 330 and the termination field 340 or storage region 350. In certain embodiments, the vertical channel C is defined by one or more retaining members 245. In certain embodiments, the retaining members 245 include two members that cooperate to wrap around the splitter pigtails 303. For example, ends of the two members can fasten together via VELCRO®, a snap-fit engagement, or via another securement arrangement.

The termination field 340 is the dividing line between the incoming fibers and the outgoing fibers of the FDH 200. At the termination field 340, the connectorized ends of the splitter pigtails 303 are connected to connectorized ends of intermediate fibers 304 that are optically coupled (i.e., linked) with fibers 305f of the subscriber cable 305. For example, in one embodiment, the intermediate fibers 304 may be spliced to fibers 305f of the subscriber cable 305 at a second fiber interface 360. In certain embodiments, the second fiber interface 360 is located within the enclosure 202 and not located on the swing frame 230. For example, the second fiber interface 360 can be located on the back wall 204 of the enclosure 202 (see FIG. 6). In the example shown, the second fiber interface 360 is located beneath the first fiber interface 310 (see FIG. 7).

In certain embodiments, one or more fibers of the feeder cable 301 are not optically coupled to the splitter modules 700. For example, in some embodiments, one or more of the feeder fibers 301f can be routed directly to the termination field 340 to optically connect to an intermediate fiber 304. In accordance with aspects of the disclosure, the feeder cable fibers 301f can be routed to the same side of the termination field 340 as the splitter pigtails 303. By refraining from splitting the signal carried by the fiber 301f, a stronger signal can be sent to one of the subscribers 115.

In other embodiments, these fibers pass through the FDH 200 and are routed to a subsequent stop in the network 100 (e.g., another FDH, a drop terminal, etc.). Such fibers are referred to herein as “pass-through” fibers 306. In certain embodiments, the pass-through fibers 306 can be routed to one or more of the fiber interface devices 320, 360 at which the pass-through fibers 306 are optically coupled (e.g., spliced) to subscriber fibers 305f. In other embodiments, however, the pass-through fibers 306 are routed about the interior of the enclosure 202 in one or more loops prior to exiting the enclosure 202 at the port 310. For example, in one embodiment, a pass-through fiber 306 can extend in an unbroken length from the feeder cable 301 to the subscriber cable 305.

Referring now to FIGS. 6-11, details about one example FDH 200 are disclosed. FIGS. 6 and 7 show an example enclosure 202 with the door 210 pivoted to an open position to expose an interior of the enclosure 202. The swing frame 230 of the FDH 200 is not visible in FIGS. 6 and 7. A cable clamp 400 for securing one or more cables to the enclosure 202 is mounted to the main body of the enclosure 202. In the example shown in FIGS. 6-11, the cable clamp 400 is mounted through a hole defined in the bottom wall 205 the enclosure 202. An example cable clamp 400, which will be disclosed in greater detail herein, is shown in FIGS. 12-14.

A first plurality of splice trays 500 are mounted at a first interface region 320 located on the back wall 204 of the enclosure 202. A second plurality of splice trays 500 are mounted at a second interface region 360 located beneath the first interface region 320. In accordance with certain embodiments, multiple splice trays 500 can be mounted together to form a splice tray stack (e.g., see the second interface region 360 of FIG. 6). For example, the splice trays 500 can be pivotally mounted together.

In accordance with some aspects, the splice trays 500 of the stack can be oriented in a vertical position for storage so that the cover of the top-most splice tray 500 faces the open front of the enclosure. When access to one of the splice trays 500 is desired, an appropriate portion of the stack can be pivoted so that the splice tray 500 to be accessed is oriented generally horizontally. In accordance with other aspects, the splice trays 500 can be oriented to be vertical both in the storage position and in the access position (e.g., see the second interface region 360 of FIG. 6).

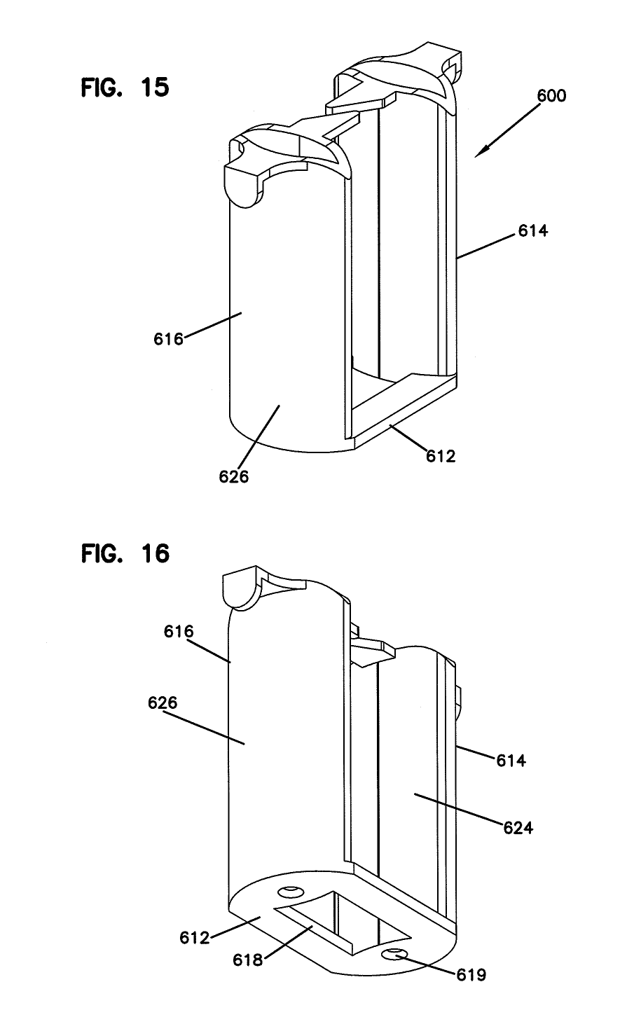

Additional information about an example splice tray 500 suitable for use in the example FDH 200 can be found in copending and commonly assigned application Ser. No. 12/425,241, filed Apr. 16, 2009, entitled “Fiber Optic Splice Tray,” the disclosure of which is hereby incorporated by reference herein. Cable management structures, such as bend radius limiters, can be positioned within the enclosure 202 to aid in routing fibers to the various telecommunications components. For example, one or more bend radius limiters 241 can be located around one or both interface regions 320, 360 of the enclosure 202. In certain embodiments, a dual bend radius limiter 600 can be positioned at one or both interface regions 320, 360. In the example shown, six dual limiters 600 are positioned along a periphery of the second interface region 360. An example dual bend radius limiter 600, which will be disclosed in greater detail herein, is shown in FIGS. 15-19.

Referring to FIGS. 8-11, the swing frame 230 is pivotally mounted to the enclosure 202 to move between a first (e.g., closed) position and a second (e.g., open) position. The swing frame 230 has a base panel 231 having a first side 235 and a second side 236. In one embodiment, the swing frame 230 is connected to the enclosure 202 by a hinge arrangement 239 (FIG. 7) defining a second vertical hinge axis A2 (FIG. 9) located adjacent the first hinge axis Al of the enclosure door 210. For example, the second hinge axis A2 can be located at a front corner of the main body of the enclosure 202. The vertical hinge axis A2 allows the swing frame 230 to be swung between the first position (see FIG. 4), in which the swing frame 230 blocks access to the back wall 204 of the enclosure, and the second position (see FIG. 6), in which the swing frame 230 is pivoted such that the second side 236 of the swing frame 230 is accessible.

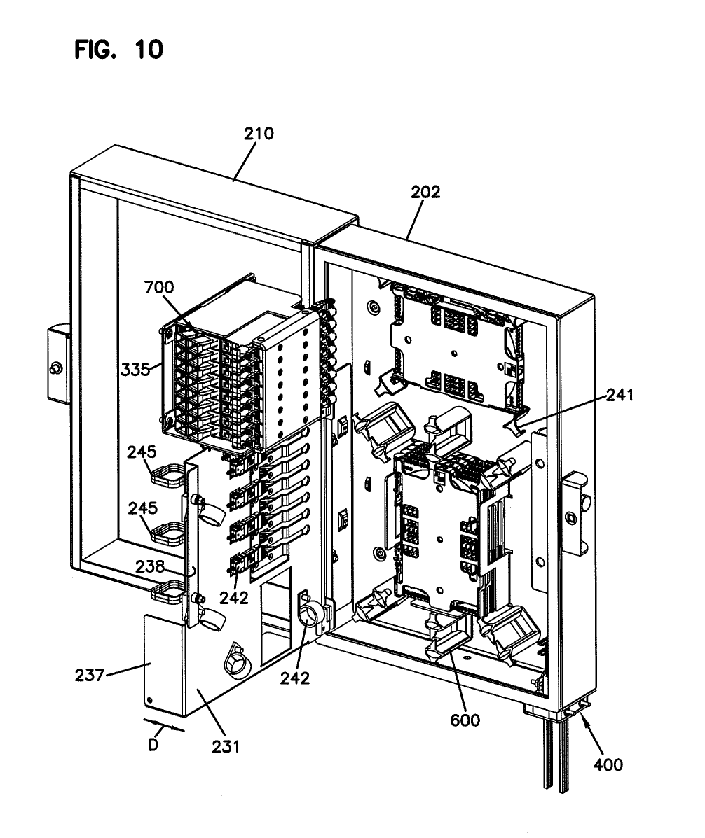

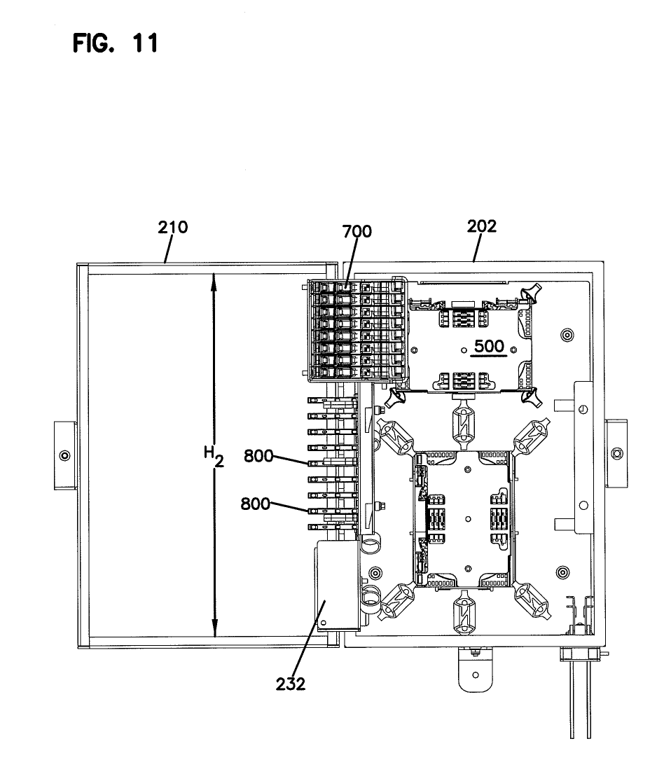

In accordance with some aspects, the swing frame 230 has a generally rectangular configuration having a height H₂ (FIG. 11) that corresponds generally to the height H of the enclosure 202 and a width W₂ (FIG. 9) that corresponds generally to the width W of the enclosure 202. In certain embodiments, the swing frame 230 also has a depth D₂ (FIG. 10) that is comparable to the depth D of the enclosure 202. In such embodiments, the swing frame 230 is located outside the enclosure 202 even when the swing frame 230 is arranged in the closed position to accommodate cable management structures provided on the back wall 204 of the enclosure and on the rear side of the swing frame 230. In such embodiments, the cover 210 has a depth D_{C} sufficient to accommodate the swing frame 230 and any telecommunications components stored thereon. A number of telecommunications components are mounted on the front side 235 of the swing frame 230. For example, a splitter mounting location 330 for mounting fiber optic splitter modules 700 is located adjacent the top of the swing frame 230. A termination field 340 is located beneath the splitter mounting location 330. A connector storage location 350 is positioned beneath the termination field 340. One or more retaining members 245 define a vertical cable management channels C that extends vertically along the front 235 of the swing frame 230. Additional cable management structures (e.g., fiber storage loops, fiber radii bend limiters, storage clips, etc.) also can be provided.

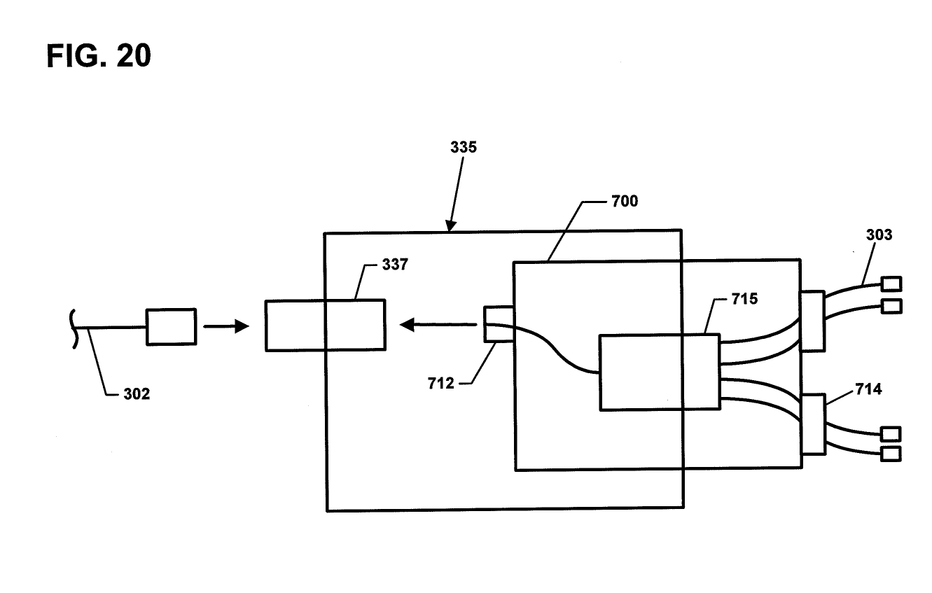

The splitter mounting location 330 has a plug-and-play configuration. In this configuration, the fiber optic splitter modules 700 containing fiber optic splitters 715 are inserted into a mounting enclosure 335 at the splitter mounting location 330 and optically connected to splitter input fibers 302. A schematic diagram of one example splitter mounting enclosure 335 is shown in FIG. 20. The splitter mounting enclosure 335 includes one or more fiber optic adapters 337. A connectorized end of one of the input fiber 302 (i.e., or feeder fiber 301) plugs into a first port of one of the adapters 337.

A fiber optic connector 712 mounted on a fiber optic splitter module 700 plugs into the second port of the adapter 337 to couple the input fiber 302 to a splitter 715 arranged within the fiber optic splitter module 700. Within the splitter modules 700, the signals from the input fiber 302 are split at the splitter 715 and directed into a plurality (e.g., 8, 16, 32, etc.) of pigtails 303. The ends of the pigtails 303 include fiber optic connectors.

In certain embodiments, the pigtails 303 extend through one or more exit members (e.g., boots) 714 on the splitter module 700.

Splitter modules 700 and plug and play arrangements similar to those shown herein are described in greater detail in commonly owned U.S. Pat. Nos. 7,376,322, issued May 20, 2008; 7,400,813, issued Jul. 15, 2008; 7,418,181, issued Aug. 26, 2008; and 7,376,323, issued May 20, 2008, the entire disclosures of which are hereby incorporated herein by reference.

As shown in FIGS. 8 and 9, when the splitter modules 700 are plugged into the mounting enclosure 335, the boots 714 of the splitter modules 700 align. For example, the splitter modules 700 can be oriented and aligned such that the splitter pigtails 303 extend downwardly along the vertical cable management channel C to retention flanges 237, which extend forwardly of the swing frame base panel 231 (e.g., see FIGS. 8-10). In certain embodiments, the splitter modules 700 slid into the mounting enclosure 335 horizontally and stacked one-on-top of the other (e.g., see FIGS. 8-11). For example, the splitter modules 700 can be positioned such that the major surfaces of the splitter module 700 extend horizontally as shown in FIG. 11.

Some of the downwardly routed pigtails 303 are looped back upwardly and plugged into termination modules 800 at the termination field 340 so as to be optically connected to another optical fiber (e.g., an intermediate fiber 304 corresponding to a subscriber fiber 305). Other connectorized pigtails 303 extend downwardly along the vertical cable management channel C and are stored at storage modules 900 mounted at the connector storage location 330.

The termination region 340 (e.g., termination modules 800) of the FDH 200 provides an interconnect interface for optical transmission signals at a location in the network where operational access and reconfiguration are desired. For example, as noted above, the FDH 200 can be used to split the feeder cables and terminate the split feeder cables to distribution cables routed to subscriber locations 115 (FIG. 1). In addition, the FDH 200 is designed to accommodate a range of alternative sizes and fiber counts and support factory installation of pigtails, fanouts, and splitters.

The termination field 340 includes a plurality of termination modules 800 that are disposed on the swing frame 230. Each termination module 800 includes a horizontal row of fiber optic adapters (e.g., a row of 6 fiber optic adapters). Each of the fiber optic adapters includes a first port facing toward a first direction for receiving a connector terminating one of the splitter pigtails 303. Each of the fiber optic adapters also includes a second port facing toward an opposite direction for receiving a fiber optic connector termination an intermediate fiber 304. As is known in the art, the fiber optic adapters are configured to providing an optical coupling between fiber optic connectors inserted into the ports.

The termination modules 800 are moveable (e.g., slideable) between a retracted position and an extended position. The retractable/extendable configuration of the termination modules 800 facilitates accessing the densely populated fiber optic adapters. Moving a termination module 800 into the extended position provides enhanced access to the ports of the extended termination module 800 and, accordingly, to the connectors plugged into the ports. Similar sliding adapter modules are described in greater detail in commonly owned U.S. Pat. Nos. 5,497,444; 5,717,810; 6,591,051; and in U.S. Patent Publication Nos. 2007/0025675; 2009-0110359, the disclosures of which are hereby incorporated herein in their entirety.

The termination modules 800 move (e.g., slide) along a slide axis when moved from the retracted position to the extended position. For example, the termination modules 800 can be oriented to slide in a forward-to-rearward direction (e.g., toward and away from the base panel 231 of the swing frame 230). In accordance with other aspects, however, the side axis of the termination modules 800 can extend at a non-orthogonal angle to the base panel 231.

Fiber optic adapters of the termination modules 800 having ports defining insertion axes along which fiber optic connectors can be plugged into the fiber optic adapters. The ports face laterally outwardly toward the sides of the swing frame 230. The fiber optic connectors extend laterally outwardly from the ports of the termination modules 800 along the insertion axes. The width W₂ of the swing frame 230 is sufficiently wide to accommodate the minimum bend radius of the splitter pigtails 303 and the intermediate fibers 304 as these fibers extend outwardly from the adapters. Due to the orientation of the termination modules 800, the depth D2 of the swing frame 230 and, accordingly, the depth D_{C} of the cover 210 need not be sufficiently deep to accommodate such a minimum bend radius limit.

The connector storage location 350 includes a panel 232 defining one or more openings at which panel-mounted connector storage blocks 900 can be mounted. For example, each connector storage block 900 can include a snap-fit connection mechanism to secure the connector storage block 900 to one of the panel openings. The connector storage blocks 900 are adapted for storing and protecting the connectorized ends of the splitter pigtails 303 when the splitter pigtails 303 are not connected to the termination field 340.

In one embodiment, the connector storage blocks 900 are configured to receive the connectorized ends of the pigtails 303 when dust caps are mounted over ferrules of the connectorized ends. In another embodiment, each of the connector storage blocks 900 includes an integral (one-piece) housing defining openings leading to an interior in which the connectorized ends can be stored. In another embodiment, the housing is made from plastic. Further details regarding example embodiments of the connector storage blocks 900 can be found in U.S. Pat. Nos. 7,277,620 and 7,198,409, which are hereby incorporated herein by reference.

An example cable clamp 400 is shown in FIGS. 12-14. The cable clamp 400 includes a jacket clamp 410, a first retaining member 420, a second retaining member 430, a secondary clamp 440, one or more buffer retainers 450, and a retention block 460. The jacket clamp 410 and the secondary clamp 440 facilitate securing cables, such as feeder cable 301 and subscriber cable 305, to the enclosure 202. Retaining members 420, 430 cooperate to secure the jacket clamp 410 to the enclosure 212. The buffer retainers 450 support buffer tubes into which cut fibers from the secured cables can be routed. The retention block 460 provides support for the buffer retainers 450 and the secondary clamp 440.

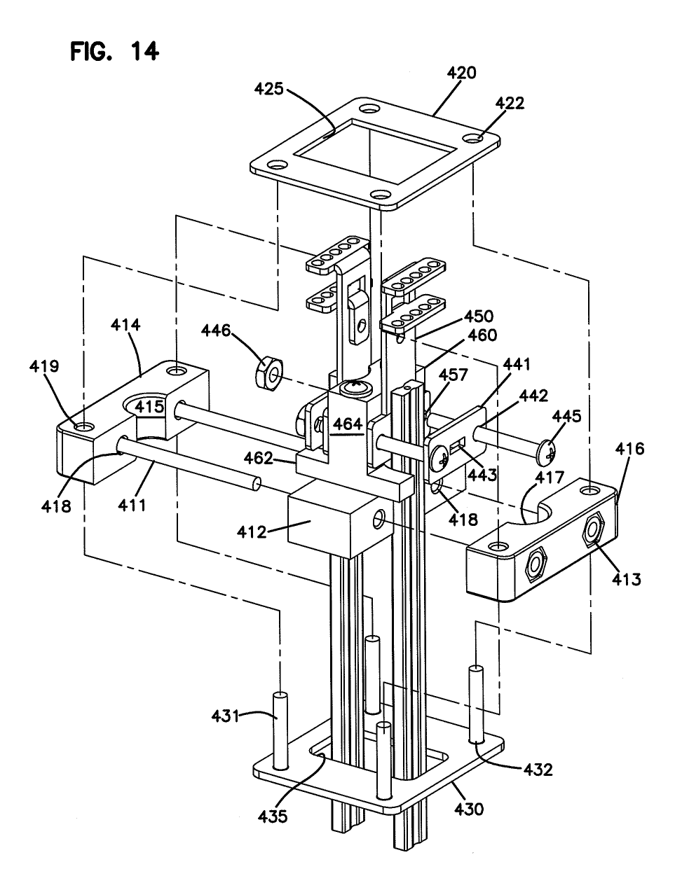

As shown in FIG. 14, the jacket clamp 410 includes a middle portion 412, a first end portion 414, and a second end portion 416. Cables can each be clamped between the middle portion 412 and one of the end portions 414, 416. In certain embodiments, at least the end portions 414, 416 define grooves 415, 417, respectively, to accommodate the cables being clamped. In one embodiment, the middle portion 412 also defines grooves that align and cooperate with the grooves 415, 417 of the end portions 414, 416. One or more fasteners 411 extend through channels 418 defined through each portion 412, 414, 416 of the clamp 410. In the example shown, each portion 412, 414, 416 defines two horizontal channels 418. The fasteners 411 can be secured via nuts 413.

The retaining members 420, 430 sandwich the jacket clamp 410 therebetween to form a clamp base. In certain embodiments, the clamp base mounts to an exterior of the enclosure 202. Each retaining member 420, 430 defines a through-opening 425, 435, respectively, through which cables can extend into the enclosure 202. In certain embodiments, one or more of the clamp portions 412, 414, 416 can define gaskets that inhibit moisture, dirt, or other contaminants from entering the enclosure 202 through the through-openings 425, 435. In other embodiments, a separate gasket can be added to the clamp base to provide a seal between the interior of the enclosure 202 and the outside environment.

Each retaining member 420, 430 also defines one or more openings 422, 432, respectively, through which one or more fasteners 431 extend. These openings 422, 432 align with openings 419 defined in the jacket clamp 410 to enable the fasteners 431 to secure the retaining members 420, 430 to opposing ends of the jacket clamp 410. In certain embodiments, the fasteners 431 also can pass through openings in the side wall 205 of the enclosure 202 to secure the cable clamp 400 to the enclosure 202.

For example, in the embodiment shown in FIG. 14, the first retaining member 420 defines an opening 422 at each of the four corners of the first retaining member 420. The second retaining member 430 defines an opening 432 at each of the four corners of the second retaining member 430. The openings 432 of the second retaining member align with the openings 422 of the first regaining member 420. The end portions 414, 416 of the jacket clamp 410 also can define openings 419 at the corners that align with the openings 422, 432 of the retaining members 420, 430. The retention block 460 seats on the middle portion 412 of the jacket clamp 410. The retention block 460 includes a main body 464 that extends upwardly from the jacket clamp 410. Legs 462 protrude outwardly from the main body 464 to provide a seat on which the second clamp 440 can rest. Strength member retainers 465 can be provided on the main body 464 of the retention block 460. For example, in accordance with one aspect, one or more screws can be provided at a top of the retaining block 460 to provide a retainer 465 about which strength members (e.g., aramid fiber) of cables can be secured.

The buffer retainers 450 are secured between the retention block 460 and the secondary clamp 440. The buffer retainers 450 include elongated bodies 451 that extend from a first end to a second end. The first end of each retainer body 451 defines at least a first platform 452. The second end of each retainer body 451 forms a support base 456 that defines through-openings 457.

In certain embodiments, a second platform 453 also can be defined at the first end of each body 451. For example, an extension 454 of the second platform 453 can be secured to the body 451 through an opening as shown in FIG. 12. Each platform 452, 453 defines one or more through openings 455. Typically, the openings 455 of the second platform 453 align with the openings 455 of the first platform 452. One or more buffer tubes can be mounted to the buffer retainers 450. For example, a buffer tube can be inserted through one set of aligned openings 455 of the two platforms 452, 453. When cables (e.g., feeder cable 301 and subscriber cable 305) are mounted to the jacket clamp 410, fibers from the cables can be cut and routed into the buffer tubes supported by the buffer retainers 450. The buffered fibers are thereby protected when they are routed to the fiber interfaces 320, 360.

The secondary clamp 440 includes at least one body 441 that defines at least one through-opening 442 sized and configured to receive a fastener 445. In the example shown in FIG. 14, each body 441 defines two through-openings 442. In certain embodiments, each body 441 also defines a central opening 443 located between the two through-openings 442. The fasteners 445 extend through the through-openings 442 of the first clamp body 441, through the through-openings 457 of the support base 456 of a buffer retainer 450, and through a channel defined in the main body 464 of the retention block 460. A cable being secured to the enclosure 202 can extend upwardly between the support base 456 and the clamp body 441.

In the example shown, the secondary clamp 440 includes a first body 441 and a second body 441′. The fasteners 445 also extend from the channel defined in the main body 464, through a support base 456 of a second buffer retainer 450, and through the second clamp body 441′ on an opposite side of the retention block 460. A second cable being secured to the enclosure 202 can extend upwardly between a support base of another buffer retainer 456 and the second clamp body 441′. The fasteners 445 can each be secured to the second clamp body 441′ with a nut 446.

FIGS. 15-19 disclose one example embodiment of a dual bend radius limiter 600. The dual limiter 600 includes a base 612, a first retention member 614, and a second retention member 616. The retention members 614, 616 extend upwardly from opposite ends of the base 612. The base 612 defines an opening 618 extending between the retention members 614, 616. The base 612 also can define mounting openings 619 sized and configured to receive fasteners for mounting the limiter 600 to a panel or other surface. In some embodiments, the retention members 614, 616 are hollow. In other embodiments, the retention members 614, 616 can be solid.

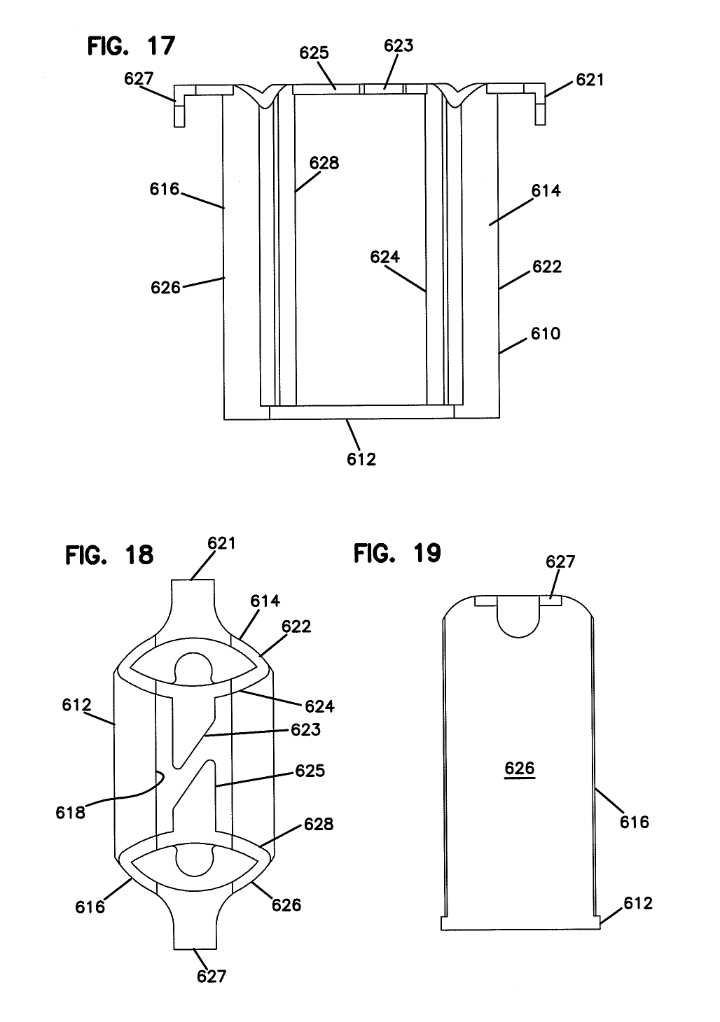

In general, each retention member 614, 616 defines two different bend radius surfaces. In certain embodiments, each retention member 614, 616 defines an outer bend radius surface and an inner bend radius surface. Each retention member 614, 616 also includes an inner tab and an outer tab to facilitate fiber retention. For example, the first retention member 614 can define an outer bend radius surface 622, an inner bend radius surface 624, an outer tab 621, and an inner tab 623 as shown in FIGS. 17 and 18. The second retention member 616 can define an outer bend radius surface 626, an inner bend radius surface 628, an outer tab 627, and an inner tab 625.

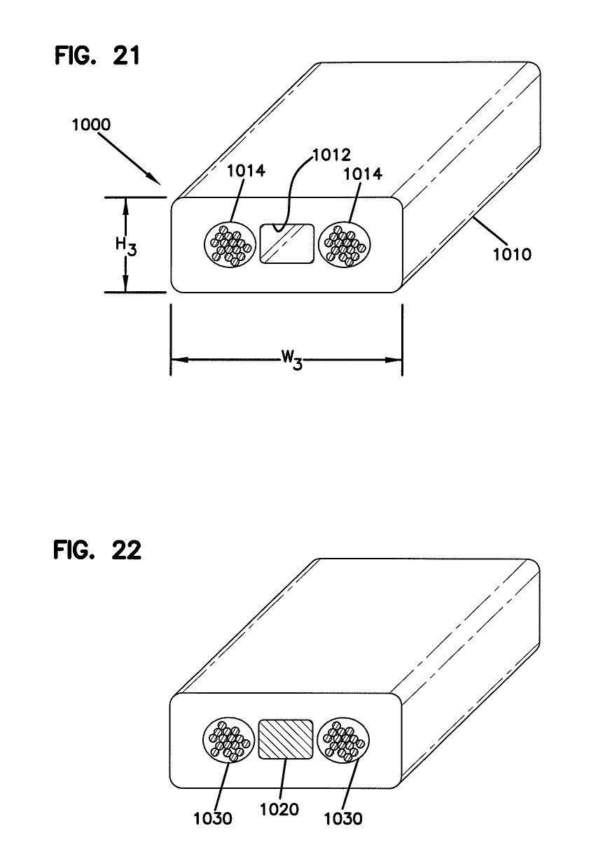

FIGS. 21 and 22 show an example telecommunications cable suitable for use as a feeder cable 301 and/or subscriber cable 305. In general, the cable 1000 has an elongated lateral cross-section. For example, in certain embodiments, the cable 1000 has a generally rectangular shape having a width W3 and a height H3. Typically, the width W3 is elongated relative to (i.e., greater than) the height H3. In some embodiments, the cable 1000 has rounded corners. In accordance with some aspects, the cable 1000 is extruded in long segments.

Each segment of cable 1000 defines a central through-passage 1012 located between two outer through-passages 1014. The through-passages 1012, 1014 are generally aligned along the axis of elongation. In the example shown, the through-passages 1012, 1014 are aligned along the width W3 of the cable 1000. The central through-passage 1012 also has an elongated lateral cross-section. In some embodiments, the lateral cross-section of the central through-passage 1012 also is rectangular. The outer through-passages 1014 are generally round or elliptical. A strength member 1020 (FIG. 22) can be positioned within the central through-passage 1012. The dimensions of the strength member 1020 generally complement the dimensions of the central through-passage 1012. Accordingly, the strength member 1020 has a preferred bending axis. In the example shown, the strength member 1020 bends along its width more easily than along its height. In accordance with certain embodiments, the strength member 1020 is made from glass reinforced polymer.

Fibers 1030 can be routed through the two outer passages 1014. In accordance with certain aspects, the fibers 1030 are not surrounded by buffer tubes. In accordance with one aspect, the fibers 1030 have a diameter of about 245 microns. Neither of the outer passages 1014 include buffer tubes. In some embodiments, water swellable yarns can be routed through the outer passages 214. In some embodiments, a rip cord can be routed through each of the outer passages 214.

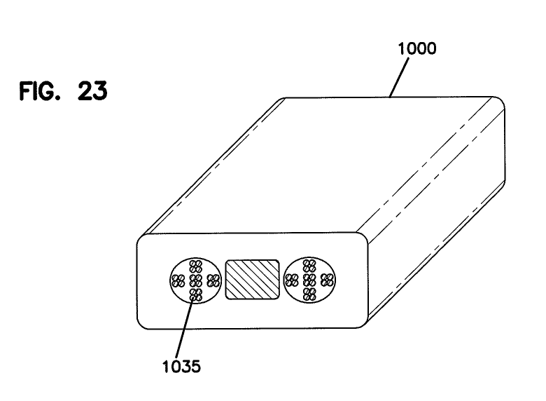

In accordance with certain embodiments, the fibers 1030 extending through the outer passages 1014 can be grouped together using a thread wrap. For example, the fibers 1030 can be grouped together using a reverse helical wrap of thread. In some example embodiments, sixteen fibers 1030 are routed through each outer passage 1014. In one example embodiment, the fibers 1030 in each outer passage 1014 are wrapped into groups of four fibers 1030 (e.g., see FIG. 23).

The cable 1000 is suitable for use as a feeder cable 301 and/or subscriber cable 305 in a telecommunications network, such as network 100 of FIG. 1. At various points along the network, access terminals can be mounted on the cable 1000 to enable access to fibers 1030 of the cable 1000. In certain embodiments, an example access terminal can have four ports, each receiving a terminated end of one optical fiber 1030 of the cable 1000. For example, one of the groups 1035 of four fibers 1030 can be routed to the ports of the access terminal. Additional details pertaining to the access terminal can be found in copending provisional application Ser. No. 61/253,723, filed Oct. 21, 2009, to Solheid et al., and titled “Fiber Access Terminal Mounted at a Mid-Span Access Location of a Telecommunications Cable,” the disclosure of which is hereby incorporated by reference herein.

In use, a feeder cable 301 having feeder fibers 301f is routed into the enclosure 202 through the cable port 310. In accordance with certain aspects, the feeder cable 301 and the subscriber cable 305 are formed from portions of the same cable. For example, fibers of a telecommunications cable can be accessed at a midpoint by stripping away the surrounding jacket at the midpoint. Jacketed cable segments on either side of the midpoint access location are secured to the enclosure (e.g., using the cable clamp 400 shown in FIGS. 12-14). For example, strength members of the cable segments can be secured to strength member retainers 465 of the cable clamp 400 (FIG. 12).

One or more of the fibers from the cable can be cut and fed into buffer tubes prior to routing the fibers to a fiber interface region (e.g., fiber interface 320, 360). In certain aspects, fibers from both cable segments are upjacketed. For example, in accordance with some aspects, the fibers can be fed into buffer tubes that are supported by buffer retainers 450 at the cable clamp 400 (see FIGS. 12-14). In accordance with other aspects, however, one or more fibers from the cable can remain uncut. For example, some pass-through fibers can remain uncut. In some embodiments, excess length of such fibers can be directed to cable management structures (e.g., fiber spools). In some embodiments, the cable includes a stub cable having fiber ends located outside the enclosure 202 that are spliced or otherwise connected to another length of feeder cable that extends to a location, such as a central office. In one embodiment, the stub cable is installed in the enclosure 202 prior to installation of the enclosure 202. The fiber ends of the stub cable are spliced to the other length of feeder cable during installation of the enclosure 202.

After being upjacketed, the feeder fibers 301f and the subscriber fibers 305f are routed upwardly to the fiber interfaces. For example, the feeder fibers 301f can be routed to one or more splice trays 500 located at the first interface region 320 and the subscriber fibers 305f can be routed to one or more splice trays 500 located at the second interface region 360. At the interface regions 320, 360, the fibers are spliced (or otherwise optically coupled) to fibers that have been pre-cabled within the FDH 200. For example, the feeder fibers 301f can be spliced to splitter input fibers 302 and the subscriber fibers 305f can be spliced to intermediate fibers 304.

The splitter input fibers 302 are routed up the back side 356 of the swing frame 230 to the splitter mounting location 330 where the fibers 302 are optically connected to a corresponding plug and play splitter modules 700 located at the splitter mounting location 330. The intermediate fibers 304 are routed to fan-out modules 242 (FIG. 10). At the fan-out modules 242, the intermediate fibers 304 are fanned out. The fanned out fibers 304 are routed laterally across the back side 236 of the swing frame 230 and through slots 233 defined through the base panel 231 of the swing frame 230 at a location proximate the hinge axis 239 of the swing frame 230.

In one embodiment, the slots 233 extend generally horizontally through the base panel 231 of the swing frame 230 and can include enlarged portions 234 sized for allowing a fiber optic connector (e.g., an SC connector) to pass through the slots 233. In certain embodiments, a plurality of the slots 233 or portions of a plurality of the slots 233 can be defined through a removable panel portion that forms at least a portion of the back wall of the swing frame. During installation, the panel portion can be removed to facilitate routing fibers from the back to the front of the swing frame and to facilitate positioning the fibers in the slots 233. After passing through the horizontal slots 233, the intermediate fibers 304, which have been pre-terminated with fiber optic connectors, are routed to the termination field 340 and are plugged into the second ports of the fiber optic adapters of the termination modules 800. In this way, when the connectorized splitter pigtails 303 are plugged into the first ports of the fiber optic adapters, the pigtails 303 are optically connected to corresponding intermediate fibers 304 plugged into the second ports of the fiber optic adapters.

While the cables 301 and 305 have been shown entering the enclosure 202 from the bottom, in other embodiments, these cables can enter from the top or from any other side of the enclosure 202. In certain embodiments, the feeder cable 301 and distribution cable 305 can be terminated at fiber optic connectors, which can be plugged directly into the termination modules 800 without any intermediate fibers or splitters. Also, the fiber distribution hub 200 can be provide with numerous cable management structures, such as fiber bend radius limiters, channel brackets, cable tie downs, and other structures to assist in routing fibers throughout the FDH 200.

Some embodiments of the above described FDH are suitable for use within buildings or multi-dwelling units. For example, some embodiments are suitable to mount inside closets or other enclosed spaces of limited size. Other embodiments of the above described FDH are suitable for use in an outside environment. Aspects of the FDH facilitate access to optical components within the FDH enclosure. For example, a pivoting swing frame facilitates access to components stored at the rear of the FDH enclosure. Sliding termination modules facilitate access to individual terminated fibers while allowing for dense storage of the coupled fibers.

The above specification provides examples of how certain aspects may be put into practice. It will be appreciated that the aspects can be practiced in other ways than those specifically shown and described herein without departing from the spirit and scope of the present disclosure.

What is claimed is:

1. A fiber distribution hub comprising:
an enclosure defining an interior region, the enclosure defining a cable port and at least a first interface region;
a swing frame pivotally mounted to the enclosure, the swing frame defining a splitter region, a termination region, and a storage region;
a door pivotally mounted to the enclosure, the door defining an interior region sized to accommodate the swing frame;
a plurality of splitter modules mounted to the swing frame at the splitter region, wherein the splitter modules are oriented and positioned so that splitter pigtails extending from each of the splitter modules extend directly downwardly through a vertically extending channel;
a plurality of fiber optic adapters mounted to the swing frame at the termination region; and
a cable clamp mounted to the enclosure at the cable port.

2. A cable comprising:
a body having an elongated lateral cross-section, the body defining a central through-passage located between two outer through-passages;
a strength member positioned within the central through-passage, the strength member having an elongated lateral cross-section;
a first plurality of fibers positioned in a first of the outer through-passages; and
a second plurality of fibers positioned in a second of the outer through-passages.

3. The cable of claim 2, wherein the central and outer through-passages are aligned along an elongation axis of the cable.

4. The cable of claim 2, wherein neither of the outer passages includes a buffer tube.

5. The cable of claim 4, wherein none of the fibers positioned in either of the outer through-passages has a buffer tube.

6. The cable of claim 1, wherein the fibers positioned in the outer through-passages are separated into groups using a thread wrap.
